(19) United States
(12) Patent Application Publication
(10) Pub. No.: US 2006/0074372 A1
(43) Pub. Date: Apr. 6, 2006

(54) Active capillary

(75) Inventors: Yoichi Haga, MIYAGI (JP); Masayoshi Esashi, Miyagi (JP); Takashi Mineta, Yamagata (JP); Yuta Muyari, Miyagi (JP)

Correspondence Address: HAYES, SOLOWAY P.C., 3450 E. SUNRISE DRIVE, SUITE 140, TUCSON, AZ, 85718, US

(73) Assignee: TOHOKU TECHNO ARCH CO., LTD., MIYAGI (JP)

(21) Appl. No.: 10/536,056

(22) PCT Filed: Nov. 17, 2003
(86) PCT No.: PCT/JP03/14614

§ 371 Date: May 24, 2005

(30) Foreign Application Priority Data
Nov. 29, 2002 (JP) 2002-348580

(51) Int. Cl. B01L 3/00

(52) U.S. Cl. 604/19

(57) ABSTRACT

Catheter of such a structure that Ti—Ni superelastic allow (SEA) tube has its outside covered with thin-film silicone rubber tube. The SEA tube at part whose flexion is desired is wrought to cut off multiple grooves (crenas) with thin joints left. The covering with the silicone rubber tube is effected without the use of its front end portion in the covering. When a negative pressure is applied to physiological saline placed therein, the front end portion works as a valve, and the silicone rubber tube at the wrought part yields inward so that flexion of the catheter occurs at that part.

### TECHNICAL FIELD

This invention relates to an active capillary capable of being inserted into a body cavity, for example a blood vessel, for use as an active catheter or guide wire in carrying out diagnosis or minimally invasive surgery.

### BACKGROUND ART

In recent years, minimally invasive surgery has been widely performed to diagnose and treat the affected part in the body without incising the living body on a large scale. Such minimally invasive surgery includes endoscopic surgery comprising inserting a tool or instrument through an already existing opening or pore such as the oral cavity, large intestine or urethra, and keyhole surgery comprising making a minimal hole in a living body tissue for inserting a tool or instrument through the hole.

With the progress in micromachining technology, various microactive mechanisms have been tried to freely control, from the outside, the flexional movement of a medical catheter or guide wire inserted into a blood vessel or a tubular tissue of the living body.

For example, liver cell carcinoma is a target to be treated using a catheter. In the case of a hepatic tumor 20 fed with nutrients by an artery 40, as shown in FIG. 1 (cf. IVR Interventional Radiology (Kanehara & Co., Ltd.), p. 69), the general practice is to achieve selective embolization of the blood vessel (in this case, the artery 40) feeding nutrients to cancer cells by manually operating a catheter (not shown) from outside the body. When it is necessary to attain efficient embolization of a number of blood vessels, like in this case, a catheter having flexion mechanisms is desired. However, the conventional active catheters cannot be applied to peripheral blood vessels which are of small diameter.

Further, on the occasion of insertion of a catheter or guide wire into a cerebral blood vessel branching at an angle greater than 90 degrees, the insertion becomes difficult or even impossible and therefore no successful treatment can be given. In this instance, too, a catheter having flexion mechanisms is desired. However, the conventional active catheters cannot be applied to peripheral blood vessels which are of small diameter.

In the treatment of cerebral aneurysm, the prior art treatment comprises loading a thin metal wire 65 into the aneurysm 70 by means of a manual catheter 60, as shown, for example, in FIG. 2 (cf. Electrothrombosis of saccular aneurysms via endovascular approach, Part I: Electrochemical basis, technique, and experimental results, Guido Guglielmi, Fernando Vinuela, Ivan Sepetka, and Velio Macellari, J. Neurosurg., Vol. 75, 1991, p. 2). A catheter having active flexion mechanisms is desired for inserting the catheter 60 into the entrance of the aneurysm for filling up with the thin metal wire 65. However, the conventional active catheters cannot be applied to cerebral blood vessels which are of small diameter.

Meanwhile, Patent Document 1, for instance, describes a prior art active catheter. In this instance, an active catheter is proposed which comprises a plurality of shape memory alloy actuators disposed around an inside tube and the shape memory alloy actuators are electrically heated for flexion.

Such actuators as described in this Patent Document 1 and to be rendered flexible by feeding electricity to the shape memory alloy are indeed thought to be effective in minimally invasive treatment in relatively large diameter blood vessels such as aortas. However, actuator insertion, wiring for electricity feeding and packaging for insulation and waterproofing, among others, make the structure complicated and, accordingly, it is difficult to reduce the diameter.

In Patent Document 2, there is proposed a balloon for medical tubes which is flexible as a result of partial crosslinking treatment in the peripheral direction of the balloon for medical tubes to modify the stretchability distribution.

Such a balloon for medical tubes as shown in Patent Document 2, the flexion of which is controlled by the pressure resulting from pouring a liquid, does not need any particular actuator or any lead wire for feeding electricity but can be made thin to a certain extent although a fluid flow channel for expanding the balloon is needed. However, the balloon expands outwardly on the occasion of flexion and, therefore, the use thereof in a narrow blood vessel is restricted and it is difficult to bend the same with a small radius of curvature.
[Patent Document 1]
Japanese Unexamined Patent Publication No. 11-48171
[Patent Document 2]
Japanese Unexamined Patent Publication No. 11-405

It is an object of the present invention to provide an active capillary capable of being used in minimally invasive test and treatment within the body and capable of being reduced in diameter with ease.

### DISCLOSURE OF INVENTION

To accomplish the above object, the present invention provides an active capillary characterized in that it has a double structure comprising a first elastic tube having, at that part thereof to be bent, a plurality of grooves (crenae) with joints left so as to connect the grooves and a film-made second tube and in that the second tube is deformed and the desired flexion is thereby attained by changing the pressure of a fluid within the capillary.

The active capillary may have a constitution such that the second tube is outside the first tube, the front end of the second tube is open, the fluid is a liquid and, when a negative pressure is applied to the liquid, the second tube end works as a valve and is closed.

This valve can be realized by the front end portion of the second tube being in front of the front end portion of the first tube and the front end portion of the second tube working as a valve, or by one of the grooves of the first tube having a greater pitch and the second tube portion corresponding to that groove greater in pitch working as a valve upon application of a negative pressure to the liquid.

A constitution such that the second tube is integrated in close contact with the first tube and the front end of the first and/or second tube is closed may also be employed. In this case, flexion can be attained by applying a negative or positive pressure to the fluid.

### BRIEF DESCRIPTION OF THE DRAWINGS

FIG. 1 is a drawing for illustrating the treatment of a hepatic tumor.

FIG. 2 is a drawing for illustrating the treatment of an aneurysm.

FIG. 3 is a drawing for illustrating the flexion mechanisms of a catheter according to an embodiment of the invention.

FIG. 4 is a drawing for illustrating the working of the flexion mechanisms of a catheter according to an embodiment of the invention.

FIG. 5 is a drawing for illustrating the constitution of a catheter according to another embodiment of the invention.

FIG. 6 is a drawing for illustrating the constitution of a guide wire according to an embodiment of the invention.

FIG. 7 is a drawing for illustrating some morphologies of the joints for connecting grooves or crenae.

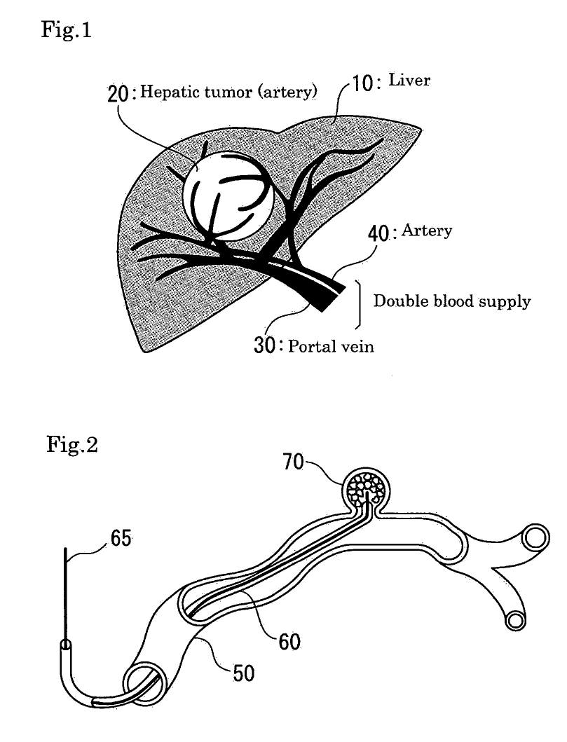

### BEST MODES FOR CARRYING OUT THE INVENTION

Now, referring to the drawings, some typical modes of embodiment of the invention are described.

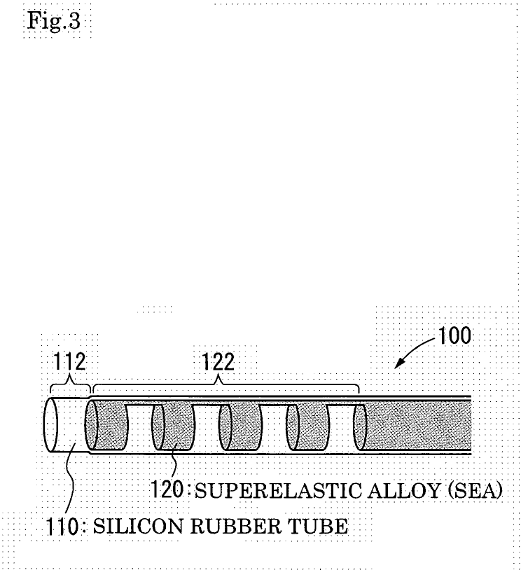

The structure of an exemplary mode of embodiment of the invention is shown in FIG. 3. FIG. 3 shows a catheter 100 of such a structure that a Ti—Ni superelastic alloy (SEA) tube 120 has its outside covered with a thin-film silicone rubber tube 110. The SEA tube 120 is wrought, at that part whose flexion is desired 122, to cut off a plurality of grooves (crenae) with thin joints left. The covering of the silicone rubber tube 110 is effected without the use of its front end portion 112 in the covering. The silicone rubber tube 110 is filled with physiological saline which is harmless to the living body.

In an example of the method of cutting grooves (crenae), the cutting can be carried out by inserting a piano wire into an SEA tube with an outside diameter of 0.88 mm and an inside diameter of 0.75 mm, fixing the whole on a stage, and cutting grooves or crenae using a femtosecond laser while feeding the whole in the axial and rotational directions. The grooves or crenae can be cut by etching as well.

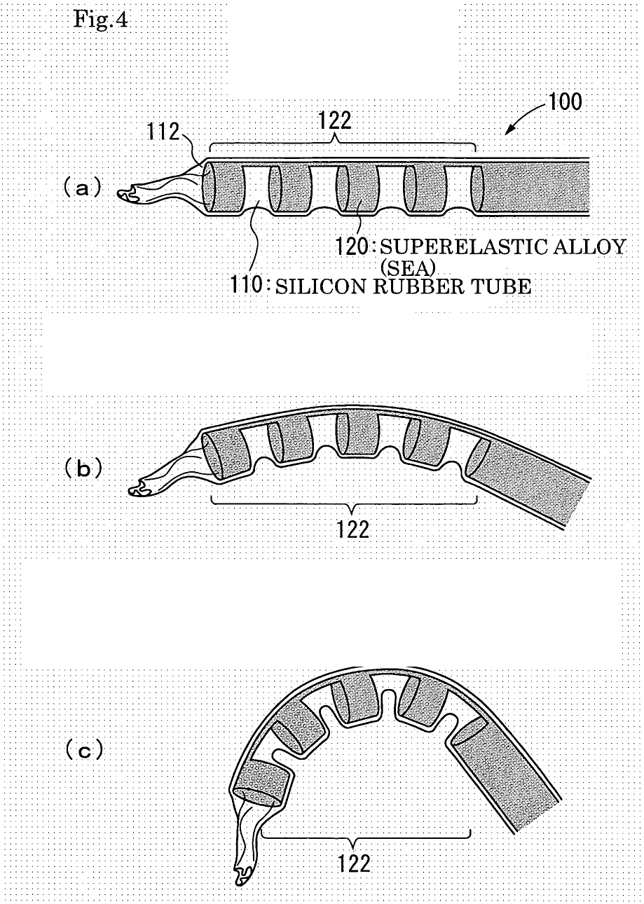

The tube 100 having the structure shown in FIG. 3 is bent at the wrought part 122 by the following procedure (cf. FIG. 4).
(1) The inside of the catheter 100 is filled with physiological saline, and the saline is suctioned strongly, whereupon that front end portion 112 of the silicone rubber tube which is not covering the SEA tube 120 works as a valve and is closed (cf. FIG. 4(a)).
(2) Further suction results in a decrease in internal pressure and, as a result, the silicone rubber tube 110 at the wrought part 122 yields inward into the plurality of grooves or crenae so that downward flexion of the catheter 100 occurs (cf. FIG. 4(b), FIG. 4(c)).

The active catheter thus manufactured, when suctioned via a polymer tube attached to the rear end of the flexion mechanisms shown, is bent as shown in FIG. 4(c).
(3) When the suction is cancelled, the original state is restored.

Flexion movements can be realized in the above manner. Physiological saline is used since it is harmless even if it enters the living body through the opening. Any other liquid may be used in lieu of physiological saline for pressure application to the active capillary provided that it is harmless to the living body.

In this way, the Ti—Ni superelastic alloy (SEA) tube is covered with the silicone rubber tube in an open state in the active capillary having the structure shown in FIG. 3 and, therefore, a treatment or test can be carried out through the opening.

Since the active capillary has a hollow structure and the function thereof as a catheter is thereby secured, the capillary can be used as a microcatheter for infusion of a contrast medium according to need or for passing a microtool for treatment therethrough after arrival at the affected part.

<Another Catheter Structure Example>

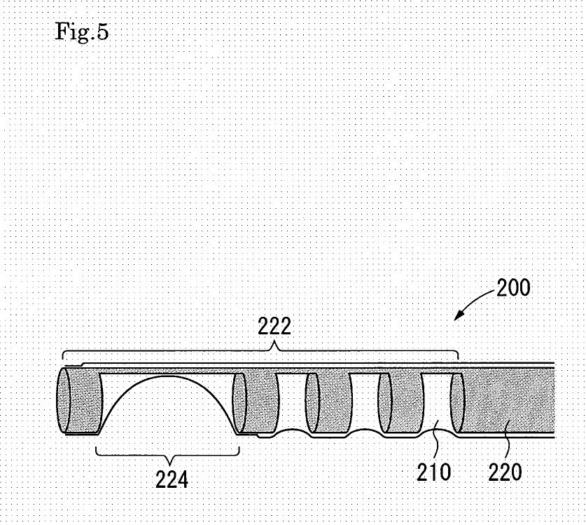

A microcatheter structure example is shown in FIG. 5 which has the same hollow structure as that shown in FIG. 3 for securing the function as a catheter.

Like FIG. 3, FIG. 5 shows a catheter 200 having a structure such that a Ti—Ni superelastic alloy (SEA) tube 220 is externally covered with a thin-film silicone rubber tube 210. In this catheter, the pitch of one of the grooves (crenae) at the wrought part 222 is widened so that the thin-film silicone rubber tube portion at that part may serve as a valve. The catheter of this type is bent upon suction, like the one having the structure shown in FIG. 3 with the front end portion working as a valve.

In the case of the catheter shown in FIG. 5, the initial strong suction exerted on physiological saline filling the catheter inside causes inward flexion of the silicone rubber wall in that wider groove section until that wall comes into contact with the SEA tube so as to work as a valve and close the front end. Further suction exerted on physiological saline causes flexion of the wrought part, namely the portion of the plurality of grooves or crenae, as in the structure shown in FIG. 3.

This structure, too, has openings and therefore the function thereof as a catheter is secured.

While, in FIG. 3 or FIG. 5, a Ti—Ni superelastic alloy (SEA) tube is used as the skeletal member of the catheter, any other material that is resistant to plastic deformation, is hardly broken and has elasticity may also be used. The covering on the skeletal member is not limited to a thin-film silicone rubber tube but any tube that is stretchable or so thin as to be folded in the grooves or crenae under pressure and is hardly broken may also be employed.

Such a double structure is required at least within the region from the bending part to the front end portion of the catheter.

<Active Guide Wire>

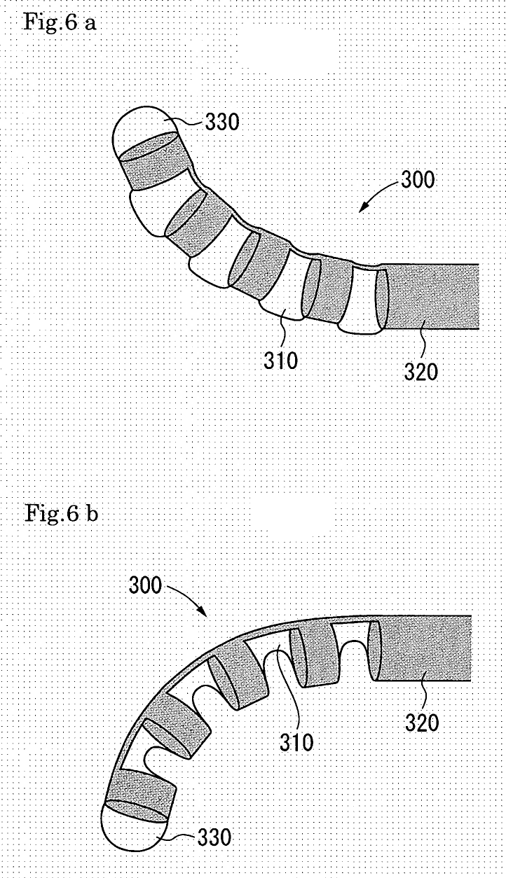

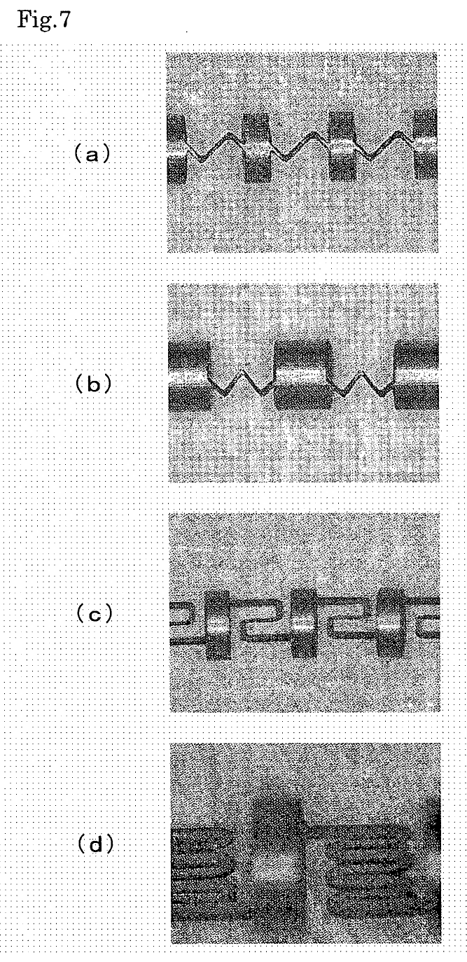

The structure of an active capillary functioning as an active guide wire 300 is shown in FIG. 6.

The structure shown in FIG. 6 is such that the front end portion of a Ti—Ni superelastic alloy (SEA) tube 320 about 0.2-0.5 mm in size is closed with a deformation-resistant polymer cap 330, a thin-film silicone rubber tube 310 is brought into close contact and integrated with the SEA tube 320 and the inside of the silicone rubber tube 310 is filled with physiological saline. The flexible part is provided with a plurality of grooves (crenae) with joints left, like that shown in FIG. 3 or FIG. 5.

In the case of the guide wire 300 having such structure, flexion is caused by applying a positive pressure or negative pressure to the inside physiological saline to expand or inwardly depress the silicone rubber tube at that portion of the plurality of grooves (crenae). Upon removal of the pressure on physiological saline, the original morphology is restored.

The direction of flexion of the wrought part having a plurality of grooves (crenae) can be changed by applying a positive pressure (cf. FIG. 6(a)) or a negative pressure (cf. FIG. 6(b)) to the physiological saline filling the inside.

While, in FIG. 6, a polymer-made cap is used as the front end portion, a metal (e.g. SEA) cap may also be used. The cap may be attached to the thin-film silicone rubber tube provided that it tightly closes the front end portion of the guide wire.

While, in FIG. 6, a Ti—Ni superelastic alloy (SEA) tube is used as the skeletal member of the guide wire, any other material that is resistant to plastic deformation, is hardly broken and has elasticity may also be used. The thin-film silicone rubber tube which is deformable and causes flexion of the guide wire is not a limitative example but may be replaced by any other tube that is stretchable and is hardly broken. The fluid for applying a pressure to the active capillary may be either a liquid or a gas and of any kind provided that it is harmless to the living body.

<Morphology of Joints Connecting Grooves (Crenae)>

The flexibility of the active capillary can be varied by changing the length and morphology of each joint connecting the grooves or crenae together in the Ti—Ni superelastic alloy (SEA) tube and enabling flexion of the active capillary. FIGS. 8(a) to 8(d) show four examples of the morphology of such joints for attaining various levels of flexibility without appreciably changing the pitch of grooves or crenae.

1. An active capillary characterized in that it has a double structure comprising a first elastic tube having, at that part thereof to be bent, a plurality of grooves or crenae with joints left so as to connect the grooves or crenae and a film-made second tube and in that the second tube is deformed and the desired flexion is thereby attained by changing the pressure of a fluid within the capillary.

2. An active capillary as set forth in claim 1, characterized in:
that the second tube is outside the first tube, the front end of the second tube is open and the fluid is a liquid and,
that when a negative pressure is applied to the liquid, the second tube end works as a valve and is closed.

3. An active capillary as set forth in claim 2, characterized in:
that the front end portion of the second tube is in front of the front end portion of the first tube and
that the front end portion of the second tube works as a valve.

4. An active capillary as set forth in claim 2, characterized in:
that one of the grooves or crenae of the first tube has a greater pitch and that the second tube portion corresponding to that groove or crenae greater in pitch works as a valve upon application of a negative pressure to the liquid.

5. An active capillary as set forth in claim 1, characterized in:
that the second tube is integrated in close contact with the first tube and the front end of the first and/or second tube is closed and
that a negative or positive pressure is applied to the fluid to attain flexion.
